(19) United States
(12) Patent Application Publication
(10) Pub. No.: US 2009/0188296 A1
(43) Pub. Date: Jul. 30, 2009

(54) METHOD AND APPARATUS FOR TESTING SMOKE AND FIRE DETECTORS

(76) Inventors: SAM D'AMICO, Kiama (AU); Jason S. D'Amico, Kiama (AU)

Correspondence Address: STETINA BRUNDA GARRED & BRUCKER, 75 ENTERPRISE, SUITE 250, ALISO VIEJO, CA, 92656, US

(21) Appl. No.: 12/020,379

(22) Filed: Jan. 25, 2008

(51) Int. Cl. G08B 29/14

(52) U.S. Cl. 73/1.02

(57) ABSTRACT

An apparatus for the testing of a smoke or fire detector; said apparatus comprising an emitter of an alarm activating material and an alarm activating material confining housing; said emitter and said housing interconnected by a flexible conduit; and wherein said housing is adapted to substantially enclose said smoke or fire detector such that said alarm activating material is brought into contact with said smoke or fire detector.

### BACKGROUND

The present invention relates to resting equipment for safety devices and, more particularly, to apparatus for testing the alarm function of smoke and fire detectors.

Smoke or fire detectors are now frequently found devices in modern homes and indeed, in many jurisdictions are required by law or building regulations. Like all devices, smoker or fire alarms are subject to occasional failure, or in the case of battery powered devices, additionally subject to malfunction through battery exhaustion.

Although most devices provide for a test facility of the electric circuitry and the status of the battery, actual testing of the working conditions of a detector should a fire eventuate, is a difficult problem and numerous devices have been devised in attempts to overcome it.

Thus devices are known in which an aerosol source activating arrangement is attached to the end of a pole or rod, in some cases with a housing which can be placed over the detector, and which then allow a spray of liquid to be ejected to test the detector. Examples may be found in U.S. Pat. No. 6,640,608 and JP09305874A. Such spraying devices have the disadvantage of leaving a wet and sometimes a permanent stain patch around the detector, as well as requiring a complicated activating mechanism.

Other devices are known which use a light source to test photoelectric type detectors but these cannot be applied to ionization type detectors.

Some smoke emitting arrangements have been disclosed, such as in JP0869585A, in which a smoke emitting device is attached to the end of a pole. Of necessity, the smoke emitting device must be small and of limited capacity and moreover this arrangement is awkward to position and probably impossible to use with a detector mounted on any surface other than a horizontal or near horizontal ceiling.

It is an object of the present invention to address or ameliorate some of the above disadvantages.

### Note

The term “comprising” (and grammatical variations thereof) is used in this specification in the inclusive sense of “having” or “including,” and not in the exclusive sense of “consisting only of.”

### BRIEF SUMMARY

Accordingly, in a first broad form of the invention, there is provided an apparatus for the testing of a smoke or fire detector; said apparatus comprising an emitter of an alarm activating material and an alarm activating material confining housing; said alarm activating material comprising a fog of smoke produced by heating a fluid; said emitter and said housing interconnected by a flexible conduit; and wherein said housing is adapted to substantially enclose said smoke or fire detector such that said alarm activating material is brought into contact with said smoke or fire detector.

Preferably, characteristics of said smoke are adapted to activate ionization type smoke or fire detectors and photoelectric type smoke or fire detectors.

Preferably, said emitter is a portable smoke emitting fogging machine.

Preferably, said alarm activating material confining housing comprises a base portion with side portions rising from said base portion; said side portions defining an open top of said housing; dimensions of said base portions and depth of said side portions adapted to substantially enclose a said smoke or fire detector when upper edges of said side portions are brought in contact with a surface supporting said smoke or fire detector.

Preferably, said base portion comprises a circular disc; said side portions forming an upwardly extending skirt integrally formed with said circular disc.

Preferably, said housing is moulded from a transparent heat resistant polymer material.

Preferably, said flexible conduit is of sufficient length for said emitter to be located on a supporting surface substantially below a said smoke or fire detector.

Preferably, said flexible conduit has an internal diameter of at least 19 mm.

Preferably, a first end of said flexible conduit attaches to an outlet nozzle of said emitter; a second end of said flexible conduit attaching to an inlet spigot of said housing.

Preferably, said inlet spigot of said housing is dispose towards a said side portion of said housing; location of said inlet spigot adapted to urge said alarm activating material to flow across said smoke or fire detector; said flow substantially parallel to said surface supporting said smoke of fire detector.

Preferably, said housing is provided with a downwardly projecting handle; said handle adapted to allow an operator of said apparatus to urge said housing into contact with a supporting surface of said smoke or fire detector.

Preferably, said downwardly projecting handle is a rigid hollow tube; said hollow tube in communication with the interior of said housing at a first upper end and connected to said flexible conduit at a lower second end.

Preferably, said emitter is provided with a remote control.

Preferably, said smoke or fire detector is mounted to a ceiling or other overhead surface.

Preferably, said apparatus is adapted for bench testing of said smoke or fire detector.

In a further broad form of the invention, there is provided a method for testing a smoke or fire detector; said method including the steps of:

(a) placing a substantially enveloping housing over said smoke or fire detector,
(b) interconnecting said housing with an emitter of a smoke or fire detector alarm activating material by means of a flexible hose,
(c) activating said emitter so as to cause said alarm activating material to flow into said housing,
and wherein said smoke or fire alarm activating material is a smoke produced by heating of a fluid.

Preferably, characteristics of said smoke are adapted to activate ionization type smoke or fire detectors and photoelectric type smoke and fire detectors.

Preferably, said emitter is a portable smoke emitting fogging machine.

Preferably, said smoke or fire detector is mounted to a ceiling or other overhead surface.

Preferably, said method includes the further steps of:

(a) placing said emitter onto a suitable supporting surface substantially below a said smoke or fire detector,
(b) raising said housing by means of an attached handle into a position wherein said housing substantially encloses said smoke or fire detector.

### BRIEF DESCRIPTION OF THE DRAWINGS

Embodiments of the present invention will now be described with reference to the accompanying drawings wherein:

FIG. 1 is a general view of the apparatus arranged for use on a smoke or fire detector mounted to a ceiling,

FIG. 2 is a detailed sectioned view of a housing for substantially enclosing the detector of FIG. 1,

FIG. 3 is a general view of a further preferred embodiment of the apparatus of FIG. 1.

### DETAILED DESCRIPTION

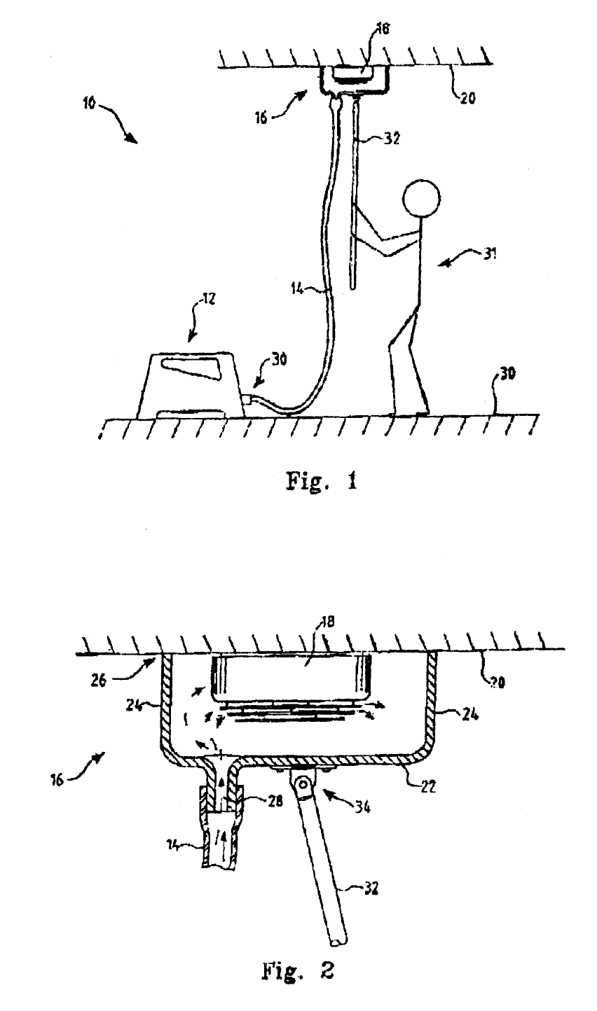

With reference to FIG. 1, an apparatus 10 according to a preferred embodiment of the present invention, includes an alarm activating material emitter 12 for a smoke or fire detector 19. Emitter 12 is interconnected via flexible conduit 14 with a housing 16.

The alarm activating material is preferably a smoke generated by a portable smoke emitting fogging machine. An example of such a machine may be found in the Antari® “Vivid V1” manufactured by the Antari Corporation, in which a suitable fluid is heated to produce a fog of smoke, capable of activating both ionization and photoelectric types of smoke or fire detectors.

Again with reference to FIGS. 1 and 2, housing 16 is arranged so as to substantially envelop a detector 18 to be tested. Typically detector 18 is mounted to, and projects downwardly from the surface of a ceiling 20.

It will be appreciated that although FIG. 1 shows a detector 18 mounted to the horizontal surface of a ceiling 20, the apparatus of the present invention may be applied with equal facility to detectors mounted to a sloping ceiling or in some overhead position on a vertical wall. It will also be obvious from the following description, that housing 16 may also be applied to detectors which are recessed into or flush mounted to a surface.

Preferably, with reference also to FIG. 2, housing 16 comprises a circular disc base portion 22 with side portions forming an upwardly projecting skirt 24. The diameter of base portion 22 is substantially larger than the diameter of typical detectors, and the depth of skirt 24 is significantly greater than the projection of detectors from the surface to which they are mounted. Thus housing 16 may be placed over a projecting detector 18 so that the edge 26 of skirt 24 is in contact with the surface to which the detector is mounted, such as a ceiling 20, effectively enclosing the detector 18.

Housing 16 is provided with an inlet spigot 28 projecting outwardly from the outside surface of base portion 22. A flexible conduit 14 is connected to spigot 28, which is preferably offset from the centre of base portion 22 and disposed towards skirt 24. By this means, smoke entering housing 16 is initially directed at the ceiling 20 (or the mounting surface) and then flows along this surface and over and through detector 18, emulating the path of actual smoke emanating from a fire.

Housing 16 is preferably integrally moulded of a transparent and heat resistant polymer material. The transparency of the material allows an operator of the apparatus to accurately position the housing over the detector, check that smoke is properly flowing into the housing and observe any alarm signal with which some detectors may be provided.

Flexible conduit 14, also preferably of a transparent polymer, is connected to an outlet nozzle 30 of emitter 12. Preferably conduit 14 is of sufficient length to allow the emitter 12 to be placed in some convenient position on the floor 30 in a region below the location of detector 18. Preferably, the internal diameter of flexible conduit 14 is at least 19 mm to ensure adequate flow of smoke from emitter 12.

Optionally, housing 16 is provided with a detachable handle 32, of a length so as to allow an operator 31 of the apparatus 10 to position housing 16 while remaining standing on floor 30. The connection 34 of handle 32 to housing 16 may be by means of an adjustable swivel so as to allow housing 16 to be positioned against a sloping ceiling or vertical wall, or to allow a more convenient stance of the operator where, for example, some obstructing object is located below the detector.

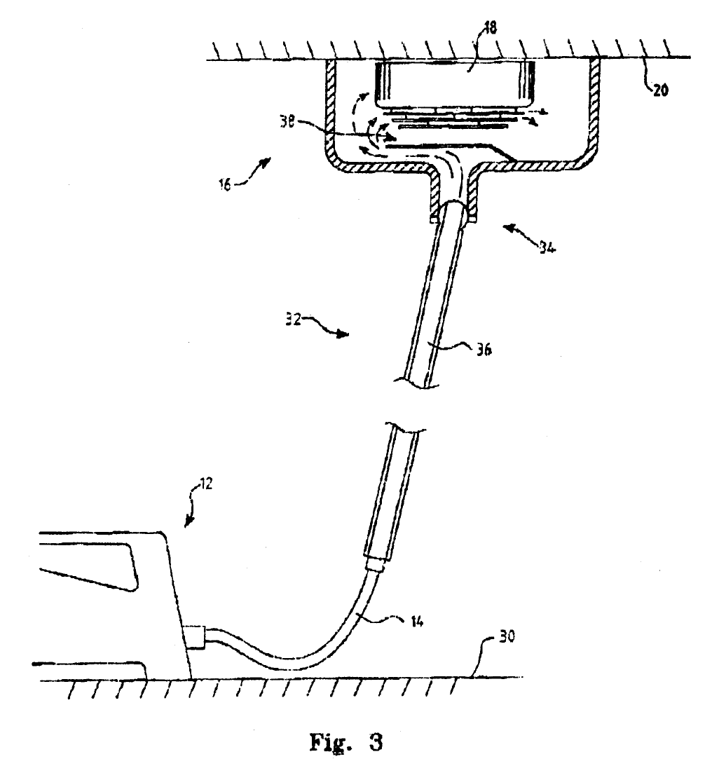

In an alternative arrangement shown in FIG. 3, handle 32 is a rigid hollow tube 36, the upper end of which is in communication with the interior of housing 16 and the lower end of which is connected to flexible conduit 14. In this arrangement also, the connection 34 of hollow tube 36 to housing 16 may be in the form of an adjustable swivel, for example a ball joint with an internal passage, such as well known to persons skilled in the art. In this embodiment, since it is preferable that the connection of handle 32 be central to the base 22 of the housing, the housing may be fitted with an internal baffle 38 to guide the smoke in a desired direction as previously described.

In at least some arrangements of the apparatus of the present invention, emitter 12 is provided with remote control facilities. Thus an operator is enabled to most conveniently position the emitter, if desired out of immediate reach, while applying and holding in place housing 16. He or she may then use the remote control unit to switch the emitter on and off as required.

Although the above description of the invention has been primarily directed at the testing of installed smoke and fire detectors, it will be appreciated that the principle components of the apparatus may equally be employed for the bench testing of detectors manufacture or repair.

### In Use

The device comprises two compartments and may be used for checking both battery powered and hard-wired (240V) smoke detectors.

The first compartment (the emitter described above) provides an active material which will pass through to the next compartment (the housing described above) by means of a hose and valve (not shown).

The second compartment (or housing) will house the smoke detector under test. When the valve of the emitter is released, the alarm activating material passes to the second chamber by means of the valve, which fills the chamber with the active material which in turn sets off the alarm, providing the smoke detector is in good working order.

The device may be adapted for bench form, that is for the testing of smoke detectors after manufacture or repair, and in mobile form as substantially described above, for testing ceiling or wall-mounted detectors.

The above describes only some embodiments of the present invention and modifications, obvious to those skilled in the art, can be made thereto without departing from the scope and spirit of the present invention.

What is claimed is:

1. An apparatus for the testing of a smoke or fire detector; said apparatus comprising an emitter of an alarm activating material and an alarm activating material confining housing; said emitter and said housing interconnected by a flexible conduit; and wherein said housing is adapted to substantially enclose said smoke or fire detector such that said alarm activating material is brought into contact with said smoke or fire detector.

2. The apparatus of claim 1 wherein said alarm activating material is a smoke.

3. The apparatus of claim 1 wherein characteristics of said smoke are adapted to activate ionization type smoke or fire detectors and photoelectric type smoke or fire detectors.

4. The apparatus of claim 1 wherein said emitter is a portable smoke emitting fogging machine.

5. The apparatus of claim 1 wherein said alarm activating material confining housing comprises a base portion with side portions rising from said base portion; said side portions defining an open top of said housing; dimensions of said base portion and depth of said side portions adapted to substantially enclose a said smoke or fire detector when upper edges of said side portions are brought in contact with a surface supporting said smoke or fire detector.

6. The apparatus of claim 5 wherein said base portion comprises a circular disc; said side portions forming an upwardly extending skirt integrally formed with said circular disc.

7. The apparatus of claim 1 wherein said housing is moulded from a transparent heat resistant polymer material.

8. The apparatus of claim 1 wherein said flexible conduit is of sufficient length for said emitter to be located on a supporting surface substantially below a said smoke or fire detector.

9. The apparatus of claim 1 wherein said flexible conduit has an internal diameter of at least 19 mm.

10. The apparatus of claim 1 wherein a first end of said flexible conduit attaches to an outlet nozzle of said emitter; a second end of said flexible conduit attaching to an inlet spigot of said housing.

11. The apparatus of claim 10 wherein said inlet spigot of said housing is disposed towards a said side portion of said housing; location of said inlet spigot adapted to urge said alarm activating material to flow across said smoke or fire detector; said flow substantially parallel to said surface supporting said smoke of fire detector.

12. The apparatus of claim 1 wherein said housing is provided with a downwardly projecting handle; said handle adapted to allow an operator of said apparatus to urge said housing into contact with a supporting surface of said smoke or fire detector.

13. The apparatus of claim 12 wherein said downwardly projecting handle is a rigid hollow tube; said hollow tube in communication with the interior of said housing at a first upper end and connected to said flexible conduit at a lower second end.

14. The apparatus of claim 1 wherein said emitter is provided with a remote control.

15. The apparatus of claim 1 wherein said smoke or fire detector is mounted to a ceiling or other overhead surface.

16. The apparatus of claim 1 wherein said apparatus is adapted for bench testing of said smoke or fire detector.

17. A method for testing a smoke or fire detector; said method including the steps of:
(a) placing a substantially enveloping housing over said smoke or fire detector,
(b) interconnecting said housing with an emitter of a smoke or fire detector alarm activating material by means of a flexible hose,
(c) activating said emitter so as to cause said alarm activating material to flow into said housing.

18. The method of claim 17 wherein said alarm activating material is a smoke.

19. The method of claim 17 wherein characteristics of said smoke are adapted to activate ionization type smoke or fire detectors and photoelectric type smoke and fire detectors.

20. The method of claim 17 wherein said emitter is a portable smoke emitting fogging machine.
